(19) United States
(12) Patent Application Publication
(10) Pub. No.: US 2026/0168300 A1
(43) Pub. Date: Jun. 18, 2026

(54) CABINET AND HOME APPLIANCE HAVING THE SAME

(71) Applicant: LG Electronics Inc., Seoul (KR)

(72) Inventors: Chungseob LEE, Seoul (KR); Hyunwoo PARK, Seoul (KR); Wonho PARK, Seoul (KR); Namgyo LEE, Seoul (KR)

(21) Appl. No.: 19/425,298

(22) Filed: Dec. 18, 2025

(30) Foreign Application Priority Data
Dec. 18, 2024 (KR) 10-2024-0189865

(51) Int. Cl. E05D 7/00; E05D 3/02

(52) U.S. Cl. CPC E05D 7/0027; E05D 3/02; E05Y 2900/31

(57) ABSTRACT

A cabinet includes a cabinet body, a door, a hinge device, and a height adjusting device configured to adjust a height of the door. The hinge device includes a hinge body installed at the cabinet, a pin unit provided at the hinge body, a guide member provided at the door and defining a pin slot to receive the pin unit. The height adjusting device include a first member provided inside the door and connected to the guide member, a second member movable relative to the first member, a third member movable relative to the second member and movable up and down by an external operating force. When the third member moves in a first direction, the second member moves upward and the height of the door is increased, when the third member moves in a second direction, the second member moves downward and the height of the door is decreased.

### CROSS-REFERENCE TO RELATED APPLICATIONS

This application claims the benefit of Korean Patent Application No. 10-2024-0189865, filed on Dec. 18, 2024. The disclosure of the prior application is incorporated by reference in its entirety.

### BACKGROUND

The present disclosure relates to a cabinet and to a home appliance, in particular to a refrigerator or clothes treatment device, having the same. In general, a refrigerator is a home appliance for storing foods in an internal storage space, which is shield by a door, at a low temperature by low temperature air. For this, the refrigerator is configured to accommodate the food in an optimum state by cooling the internal storage space using cold air generated through heat exchange with a refrigerant circulating in a refrigeration cycle.

The refrigerator may be independently placed in a kitchen or living room or may be a built-in home appliance that is accommodated in a space defined by a furniture cabinet or surrounding cabinets of the kitchen.

The refrigerator may include a cabinet forming a storage space and a door connected to the cabinet to open and close the storage space.

For example, if the refrigerator is installed inside the furniture cabinet, there is a risk that the door may hit the furniture cabinet during an opening process, which may limit an opening angle of the door.

Recently, a hinge structure has been developed to prevent the door from interfering with surrounding structures such as a furniture cabinet during a door opening process.

There is a prior art document of International Publication No. WO2019/007278A1.

Meanwhile, a height adjustment of doors may be necessary to ensure that heights of multiple doors in a refrigerator are consistent.

There is a prior art document of Korean Patent Publication No. 10-2021-0123087.

### SUMMARY

It is an object to provide a cabinet or a home appliance having the same, preferably a refrigerator with a door height that can be easily adjusted.

It is an object of the present disclosure to provide a cabinet, e.g. a cabinet for a home appliance, in particular to a refrigerator or a clothes treatment device with a door height that can be easily adjusted.

Alternatively or additionally, it is an object to provide cabinet or a home appliance having the same, that prevents interference with surrounding structures during a door opening process while increasing a door opening angle.

Alternatively or additionally, it is an object to provide cabinet or a home appliance having the same, in which a structure for a height adjustment is minimized from being exposed outside a door.

Alternatively or additionally, it is an object to provide cabinet or a home appliance having the same, in which the door can be automatically closed by an auto-closing device during a door closing process.

Alternatively or additionally, it is an object to provide cabinet or a home appliance having the same, wherein a structure for a height adjustment is prevented from interfering with the auto closing device.

The object is solved by the features of the independent claims. Preferred embodiments are given in the dependent claims.

According to one aspect of the present disclosure, a cabinet, in particular a cabinet for a home appliance, is provided, wherein the cabinet includes: a cabinet body defining a storage space and a door for opening and closing the storage space; a hinge device to allow the door to rotate relative to the cabinet; and a height adjusting member configured to adjust a height of the door.

According to one aspect, a home appliance, in particular a refrigerator or a clothes treatment device, includes a cabinet having a cabinet body defining a storage space and a door for opening and closing the storage space; a hinge device to allow the door to rotate relative to the cabinet body; and a height adjusting member configured to adjust a height of the door.

According to one aspect, a home appliance, in particular a refrigerator or a clothes treatment device, my includes a cabinet having a storage space; a door that opens and closes the storage space; a hinge device to allow the door to rotate relative to the cabinet; and a height adjusting member to adjust a height of the door.

The cabinet and the home appliance having the same according to any one of these aspects may include one or more of the following features:

The door may have a vertical rotation axis. A height of the door may be a vertical position of the door, e.g. with respect to (the body of) the cabinet.

According to one aspect a cabinet for a home appliance is provided comprising a cabinet body having a storage space; a door for opening and closing the storage space; a hinge device installed at the cabinet body and including a pin unit for rotatably coupling the door to the cabinet; and a height adjusting device coupled to the door and configured to adjust a height of the door with respect to the cabinet body, wherein the height adjusting device includes: a first member connected to a guide member of the hinge device, the guide member having a pin slot to receive the pin unit of the hinge device, a second member movable relative to the first member, a third member movable up and down relative to the second member.

The height adjusting device may include: a first member connected to a guide member of the hinge device, the guide member may have a pin slot to receive the pin unit of the hinge device, a second member movable relative to the first member, a third member movable up and down relative to the second member.

The height adjusting member may be coupled to the door such that a change in (vertical) position of the height adjusting member may correspond to a change in height of the door. The height adjusting member may be coupled to the door at a fixed relative position in vertical direction, e.g. by means of a support plate coupled to a door frame of the door.

The second member is configured to move upward to increase the height of the door, when the third member moves in a first direction.

The second member is configured to move downward to decrease the height of the door when the third member moves in a second direction.

According to one aspect, the home appliance might be a refrigerator and may include a cabinet body having a storage space; a door that opens and closes the storage space; a hinge device to allow the door to rotate relative to the cabinet; and a height adjusting device to adjust a height of the door.

The hinge device may include a hinge body installed at the cabinet. The hinge device may include a pin unit provided at the hinge body. The hinge device may include a guide member provided at the door and forming a pin slot to receive the pin unit.

The height adjusting device may include a first member provided inside the door and connected to the guide member.

The height adjusting device may further include a second member movable relative to the first member. The height adjusting device may further include a third member movable relative to the second member and movable up and down by an external operating force.

When the third member moves in a first direction, the second member may move upward, thereby increasing a height of the door. When the third member moves in a second direction, the second member may move downward, thereby decreasing the height of the door.

During a door opening process, relative positions of the pin slot and the pin unit may be varied, a rotation center of the door may be moved. The pin unit may include a first pin and a second pin.

The height adjusting device may further include a fourth member to transmit an external operating force to the third member.

The door may include an opening formed to allow a portion of the fourth member to be exposed to an outside, an opening formed to allow a tool for operating the fourth member to pass through, or an opening formed to allow the fourth member to pass through.

The fourth member is rotatably connected to the third member, and when the fourth member rotates in one direction, the third member moves in the first direction, and when the fourth member rotates in another direction, the third member moves in the second direction.

The third member may include a coupling hole to which fourth member is connected.

A screw thread may be formed on a surface forming the coupling hole, and a screw thread interacting with the screw thread may be formed on an outer surface of the fourth member.

The door may include a first surface and a second surface having different heights, and a third surface extending in a vertical direction to connect the first surface and the second surface.

The opening may be formed in the first surface or the second surface.

The third member may include a rack having gear teeth. The height adjusting device may further include a pinion gear connected to the rack.

The fourth member may be connected to the pinion gear.

The door may include a first surface and a second surface having different heights, and a third surface extending in a vertical direction to connect the first surface and the second surface.

The opening may be formed in the third surface.

The first member may include a first body extending upward from the guide member, and a second body extending from the first body in a horizontal direction.

The second body may include a first inclined surface along which the second member slides.

At least a portion of the second member is positioned between the third member and the second body, and the third member may include a second inclined surface along which the second member slides.

The second member may include a first contact surface in contact with the first inclined surface and a second contact surface in contact with the second inclined surface.

The door may further include a case installed at the door and receiving the first member, second member, and third member.

The case moves up and down together with the second member. The case moves relative to the first member and third member.

The refrigerator may further include an auto closing device provided at one side of the guide member at the door and to provide closing force to the door during a door closing process.

The second member is positioned at an upper side of the auto closing device and may overlap the auto closing device in a vertical direction.

At least a portion of the third member is positioned at an upper side of the auto closing device and may overlap the auto closing device in a vertical direction.

The height adjusting device may further include a fourth member to transmit an external operating force to the third member.

The auto closing device may be positioned between the fourth member and the guide member.

The first direction may be a downward direction, and the second direction may be an upward direction.

According to another aspect, a refrigerator may further include: a cabinet having a storage space; a door that opens and close the storage space; a hinge device to allow the door to rotate relative to the cabinet; a height adjusting device disposed within the door to adjust a height of the door; and an auto closing device to provide a closing force to the door during a door closing process.

The hinge device may include a hinge body installed at the cabinet, a pin unit provided at the hinge body, and a guide member provided at the door and forming a pin slot in which the pin unit is received.

The auto closing device may include a body installed at the door at one side of the guide member, and a lever rotatable relative to the body and interacting with the hinge body. At least a portion of the height adjusting device may be positioned farther from the guide member than a rotation center of the lever.

A portion of the height adjusting device may overlap the auto closing device in a vertical direction.

The height adjusting device may include a first member provided inside the door and connected to the guide member, a second member movable relative to the first member, and a third member movable relative to the second member and movable up and down by an external operating force.

When the third member moves in the first direction, the second member may move upward and a height of the door is increased, and when the third member moves in the second direction, the second member may move downward and the height of the door is decreased.

According to another aspect, a refrigerator may include a cabinet having a storage space; a door that opens and closes the storage space; a hinge device to allow the door to rotate with respect to the cabinet; and a height adjusting device positioned inside the door to adjust a height of the door. The hinge device may include a hinge body installed at the cabinet, a pin unit provided at the hinge body and having a first pin and a second pin, and a guide member provided at the door and forming a pin slot in which the pin unit is received.

The door may include a case that is coupled to the door and forms a space in which the height adjusting device is received.

The height adjusting device may include a first member received in the case and connected to the guide member, a second member movable relative to the first member, and a third member movable relative to the second member and movable up and down by an external operating force.

When the third member moves in the first direction, the second member and the case may move upward, increasing a height of the door. When the third member moves in the second direction, the second member and the case may move downward, decreasing the height of the door.

The configuration described above for a refrigerator can be applied to a home appliance as well.

Accordingly, a height of a door can be easily adjusted by connecting a tool to a connection recess exposed outside the door and operating the door while the door is opened or closed.

Accordingly, a door opening angle can be increased while preventing interference with surrounding structures during a door opening process.

Accordingly, a height adjusting device is positioned inside the door, with the connection recess exposed to an outside, thereby minimizing an exposure of the height adjusting device to the outside.

Accordingly, the door can be automatically closed by the auto closing device during the door closing process, and the height adjusting device for height adjustment is positioned adjacent to the auto closing device, there is an advantage that the height adjustment device is compact without interfering with the auto closing device.

Of course, the present invention may be applied to other home appliances than a refrigerator, e.g. to a clothes treatment device such as a refresher, styler, washing machine or dryer.

### BRIEF DESCRIPTION OF THE DRAWINGS

FIG. 1 is a perspective view of a refrigerator according to a first embodiment.

FIG. 2 is a drawing showing a first hinge device according to a first embodiment.

FIG. 3 is a bottom view of a first door according to a first embodiment.

FIG. 4 a perspective view showing a door frame and a height adjusting device of a first embodiment.

FIG. 5 is an exploded perspective view showing an arrangement of a door frame, a height adjusting device, and hinge device according to a first embodiment.

FIG. 6 is an exploded perspective view of a height adjusting device of a first embodiment.

FIG. 7 is a front view of a height adjusting device according to a first embodiment.

FIG. 8 is a cross-sectional view taken along line 8-8 of FIG. 3.

FIGS. 9A to 9C are drawings showing relative positions of a case and a height adjusting device when a height of the first door is adjusted according to a first embodiment.

FIGS. 10A to 10C are drawings showing relative positions of a case and a guide member of a first door when a height of a first door is adjusted according to a first embodiment.

FIG. 11 is a drawing showing a position of an opening to which a tool for height adjustment is connected at a first door according to a second embodiment.

FIGS. 12 and 13 are drawings showing a height adjusting device of a second embodiment.

FIG. 14 is a drawing showing a position of an opening for a tool according to a third embodiment.

FIG. 15 is a drawing showing a position of an opening for a tool according to a fourth embodiment.

FIG. 16 is a drawing showing a position of an opening for a tool according to a fifth embodiment.

FIG. 17 is a drawing showing a hinge device according to a sixth embodiment.

### DETAILED DESCRIPTION

Hereinafter, some embodiments of the disclosure will be described in detail with reference to the accompanying drawings. It should be noted that when components in the drawings are designated by reference numerals, the same components have the same reference numerals as far as possible even though the components are illustrated in different drawings. Further, in description of embodiments of the disclosure, when it is determined that detailed descriptions of well-known configurations or functions disturb understanding of the embodiments of the disclosure, the detailed descriptions will be omitted.

Also, in the description of the embodiments of the disclosure, the terms such as first, second, A, B, (a) and (b) may be used. Each of the terms is merely used to distinguish the corresponding component from other components, and does not delimit an essence, an order or a sequence of the corresponding component. It should be understood that when one component is “connected”, “coupled” or “joined” to another component, the former may be directly connected, coupled or jointed to the latter or may be “connected”, coupled” or “joined” to the latter with a third component interposed therebetween.

Hereinafter, a refrigerator is described as an example of a home appliance, but it should be noted that a structure for rotating a refrigerator door and a height adjusting device can be applied equally to other home appliances or storge cabinets besides the refrigerator.

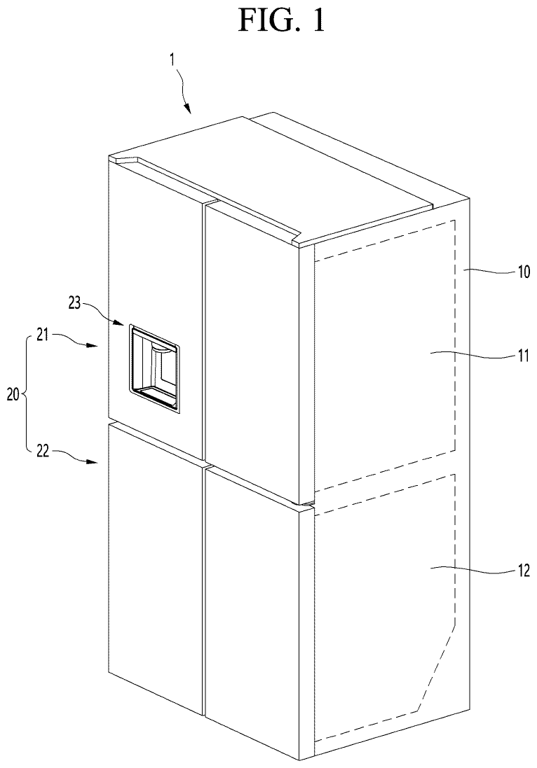

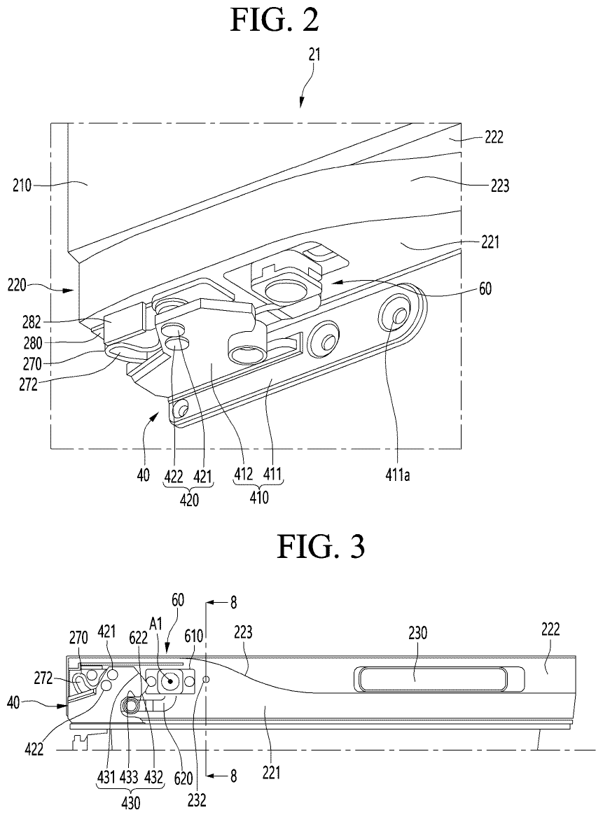

FIG. 1 is a perspective view of a refrigerator of a first embodiment. FIG. 2 is a drawing showing a first hinge device of a first embodiment. FIG. 3 is a bottom view of a first door of a first embodiment.

Referring to FIGS. 1 to 3, a refrigerator 1 of the embodiment may be independently installed at a kitchen or accommodated within an indoor furniture cabinet (hereinafter collectively referred to as a “furniture cabinet”).

When the refrigerator 1 is installed within an indoor furniture cabinet, a refrigerator 1 may be installed independently or arranged left and right with another refrigerator or kitchen shelf or cabinet. Thus, to adjust the gap dimension, the position of the door with respect to adjacent cabinets or front plates thereof is important.

The refrigerator 1 may include a cabinet having a storage space. The cabinet may have a cabinet body 10 defining the storage space. The refrigerator 1 may further include a door 20 that opens and closes the storage space and thermally shields the storage space.

The storage space may be divided into, but is not limited to, a first space at an upper side and a second space at a lower side. The door 20 may also include a first door 21 than opens and closes the first space and a second door 22 that opens and closes the second space.

The first space may be a refrigerating chamber and the second space may be a freezing chamber, or vice versa or there may be two refrigerating chambers or two freezing chambers. Alternatively, the storage space may include a first space and a second space divided left and right. Alternatively, the storage space may be a single space, and a single door may open and close the storage space.

At least one of the first door 21 or the second door 22 may be a rotary door. Alternatively, a single door 20 may be a rotary door.

Hereinafter, a rotary type door 20 will be described, with the first door 21 as an example. Here, the first door 21 may be rotatably connected to the cabinet body 10 by a hinge device.

The hinge device may include a first hinge device 40 positioned at a lower side of the first door 21 and a second hinge device positioned at an upper side of the first door 21.

The first hinge device 40 and the second hinge device have the same structure for a rotation of the first door 21, but differ in structure for installation in or at the cabinet body 10.

For example, a shape or structure of a hinge body of the first hinge device 40 and the second hinge device might be different.

Hereinafter, the first hinge device 40 will be described as an example.

The first door 21 may include a pair of doors arranged left and right. Exteriors of the pair of doors may be formed in a symmetrical shape or at least substantially symmetrical. Furthermore, each of the pair of doors may be rotatably connected to the cabinet body 10 by a hinge device.

One of the pair of doors may be provided with a dispenser 23 for dispensing water and/or ice. Of course, the dispenser 23 may be omitted.

The first door 21 may include a front panel 210 to form a front exterior. The first door 21 may further include a door frame 220 coupled to the front panel 210 and forming a lower exterior of the first door 21.

It is clear from the above that neither the refrigerating function is essential nor the number of doors. So, the invention can be applied to any cabinet having a storage room being closable by a door, when or wherein the door is rotatably connected to the cabinet enclosing the storage room by a hinge device. So, there might be only one door.

The door frame 220 may include a first surface 221. The first surface 221 may include a portion facing a hinge device 40 or hinge body 410, which will be described later. So, the hinge device might be coupled mainly on the first surface. The first surface 221 might form the lowest surface of the door and may face a floor or bottom surface.

The door frame 220 may further include a second surface 222 stepped from the first surface 221. The second surface 222 may, for example, be positioned higher than the first surface 221.

The door frame 220 may further include a third surface 223 that connects the first surface 221 and the second surface 222. The third surface 223 may form a portion of a front exterior of the first door 21.

For example, the first surface 221 and the second surface 222 may be horizontal planes or planes inclined within a predetermined angle from the horizontal plane. The third surface 223 may be a plane extending mostly vertically or a vertical plane.

The door frame 220 may include a handle 230 for a user to grasp. The handle 230 may be formed, for example, by a portion of the second surface 222 being recessed upward.

The first hinge device 40 may include a hinge body 410. The hinge body 410 may be coupled to one surface of the cabinet body 10, preferably to a vertical surface. The one surface may be, for example, a front surface of the cabinet body 10. A portion of the hinge body 410 may overlap a lower side of the first door 21 in a vertical direction.

The hinge body 410 may support a load of the first door 21. The hinge body 410 may include, for example, a coupling portion 411 coupled to the cabinet body 10 and an extension 412 extending from the coupling portion 411.

The coupling portion 411 may be coupled to, for example, a front surface of the cabinet body 10. One or more coupling holes 411a to which a coupling member is coupled may be formed in the coupling portion 411.

When the refrigerator 1 is installed in the furniture cabinet or in the kitchen, an opening angle of the first door 21 needs to be increased without interfering with the furniture cabinet or surrounding structures during an opening process of the first door 21.

In the embodiment, the opening angle of the first door 21 can be increased without interfering with a furniture cabinet or surrounding structures by the first hinge device 40 and the second hinge device. For example, the first hinge device 40 and the second hinge device may cause a rotation center of the first door 21 to be moved in at least a period among an entire opening period of the first door 21. Period here means a portion of the opening way of the door.

The first hinge device 40 described below can be equally applied to the second door 22 when the second door 22 is of a rotation type.

The first hinge device 40 may further include a pin unit 420.

The pin unit 420 may include a first pin 421 and a second pin 422. The first pin 421 and the second pin 422 may be spaced apart from the hinge body 410. The first pin 421 and the second pin 422 may be formed integrally with the hinge body 410 or may be coupled to the hinge body 410.

The first pin 421 and the second pin 422 may extend from the hinge body 410 toward the first door 21, for example. The first pin 421 and the second pin 422 may extend upward from the hinge body 410. For example, the pin unit 420 may be provided at the extension 412 of the hinge body 410.

The second hinge device may also include a first pin and a second pin, and the first pin 421 and the second pin 422 of the first hinge device 40 may be aligned vertically with the first pin and the second pin of the second hinge device.

The first door 21 may further include a pin slot 272 in which the pin unit 420, i.e. at least one pin thereof, is received. The pin slot 272 may be provided at a lower side of the first door 21. The pin slot 272 may be formed at a lower surface of the first door 21 and is recessed upward. So, the pin slot 272 may be a groove or slit. The pin slot 272 may be formed by a guide member 270. That is, the guide member 270 may include a pin slot 272 in a recessed shape, i.e. a slot in the guide member 270. The guide member 270 may be coupled to a lower side of the first door 21. For example, the guide member 270 may be coupled to the door frame 220, i.e. the lower portion of the door.

The first pin 421 and the second pin 422 may be formed in a cylindrical shape. The first pin 421 and the second pin 422 may include a flange having an expanding diameter. The flange may be in contact with the hinge body 410. For example, each of first and second pins 421, 422 may include a first portion received in the pin slot 272, and a second portion (or flange) positioned at a lower side of the first portion and positioned outside the pin slot 272. The guide member 270 may be seated on the extension 412 or seated on the flange.

The pin slot 272 may form or include a curve. A curvature of the pin slot 272 may be gradually or continuously variable. When a curvature of the pin slot 272 is gradually variable, the pin slot 272 may be divided into a plurality of portions. A curvature of each of the plurality of portions may be different from each other. The curvature of the pin slot 272 defines the moving of the rotation center of the door as mentioned above.

The first door 21 may be opened in a state in which the first pin 421 and the second pin 422 are received in the pin slot 272. A rotation center of the first door 21 may be moved depending on a shape of the pin slot 272. The rotation center of the first door 21 may be, for example, a virtual rotation center. Depending on a shape of the pin slot 272, the rotation center may be moved continuously or gradually.

By moving the rotation center of the first door 21, an opening angle of the first door 21 may be adjusted or increased without interfering with a furniture cabinet or surrounding structures during an opening process of the first door 21.

The refrigerator 1 may further include a stopping member 280. The stopping member 280 may limit a rotation of the first door 21 in a state in which the first door 21 is opened to a maximum opening angle.

The stopping member 280 may be installed, for example, at a lower side of the first door 21. The stopping member 280 may be installed at the door frame 220.

The stopping member 280 may include a stopper 282. The stopper 282 may extend in a vertical direction. When the stopper 282 is in contact with one point of an extension 412 of the hinge body 410 during an opening process of the first door 21, an opening of the first door 21 may be restricted.

The refrigerator 1 may further include an auto closing device 60 that provides closing force to the first door 21 while the first door 21 is closed. Of course, the auto closing device 60 may be omitted.

The auto closing device 60 may be installed, for example, at the door frame 220. The auto closing device 60 may be coupled to the first surface 221 of the door frame 220.

The auto closing device 60 may provide closing force to the first door 21 while interacting with the hinge body 410 during a closing process of the first door 21.

The auto closing device 60 may be installed at the first door 21 at a position adjacent to the hinge body 410.

The auto closing device 60 may include a body 610 installed at the door frame 220.

The auto closing device 60 may include a lever 620 movably installed at the body 610. For example, the lever 620 may be rotatable with respect to the body 610 based on a rotation center A1. The lever 620 may be movably connected to the body 610 while being elastically supported. For example, the auto closing device 60 may further include an elastic member (not shown) for elastically supporting the lever 620. The elastic member may be directly or indirectly connected to the lever 620 within the body 610.

The lever 620 may further include a contact portion 622 to be in contact with the hinge body 410. The contact portion 622 may be, for example, a rotatable roller or a deformable member.

While the door 20 is closed in a state in which the elastic member connected to the lever 620 has accumulated elastic force, the elastic force acts as a closing force on the first door 21, so that the first door 21 can be automatically closed.

The extension 412 may include a contact surface for interacting with the contact portion 622. The contact surface may include a first contact surface 431, a second contact surface 432, and a third contact surface 433. The second contact surface 432 may be inclined with respect to the first contact surface 431. The third contact surface 433 may be inclined with respect to the second contact surface 432.

In a state in which the first door 21 is opened at an angle greater than a set angle, the contact portion 622 is not in contact with the first contact surface 431. While the first door 21 is closed at an angle less than the set angle, the contact portion 622 may be in contact with the first contact surface 431.

While the first door 21 is closed, the contact portion 622 moves along the second contact surface 432, thereby providing a closing force to the first door 21, so that the first door 21 may be automatically closed.

When the first door 21 is completely closed, the contact portion 622 may be in contact with the third contact surface 433.

The refrigerator 1 may include a height adjusting device (described below) to adjust a height of the first door 21. For example, a height of a lower surface of the first door 21 relative to the extension 412 may be adjusted by the height adjusting device.

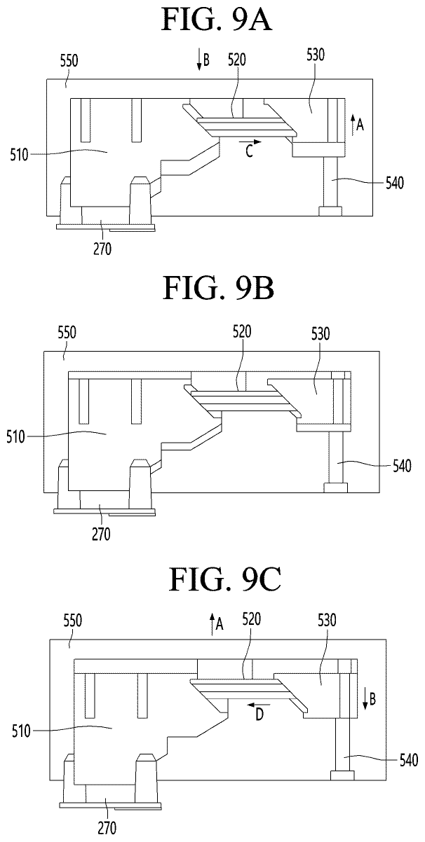

The first door 21 may be provided with an opening 232 (FIG. 9A) through which a tool for operating the height adjusting device 50 might pass.

The height adjusting device 50 may be positioned adjacent to the hinge device 40. The opening 232 may be formed in the door frame 220. FIG. 3 illustrates, as an example, that the opening 232 is formed in the first surface 221 of the door frame 220.

Hereinafter, the height adjusting device 50 will be described in detail.

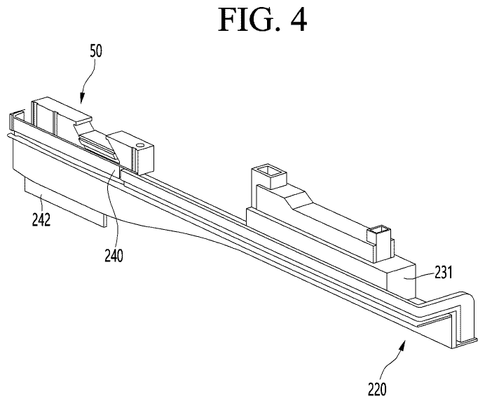

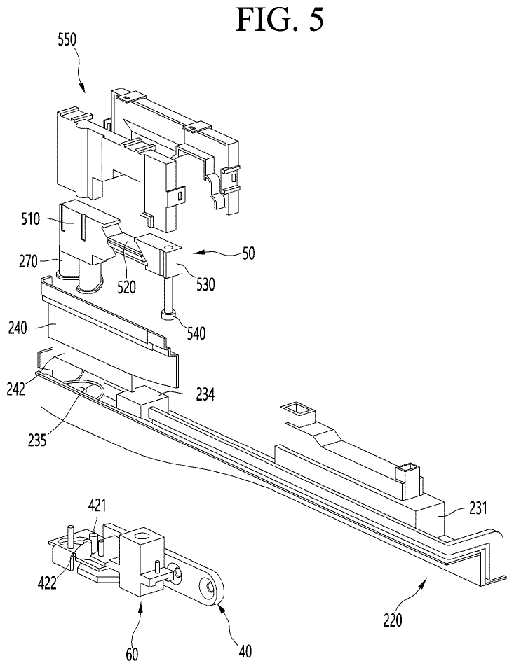

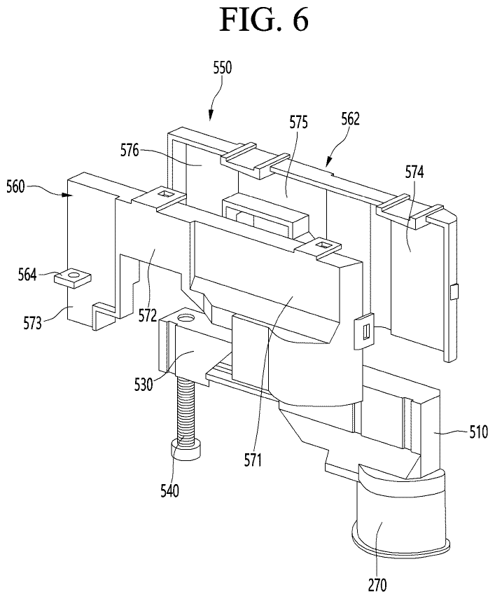

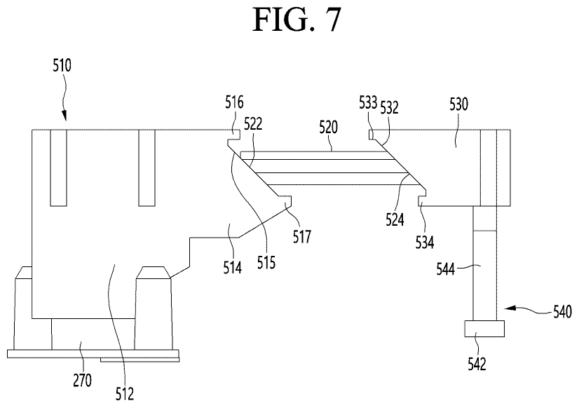

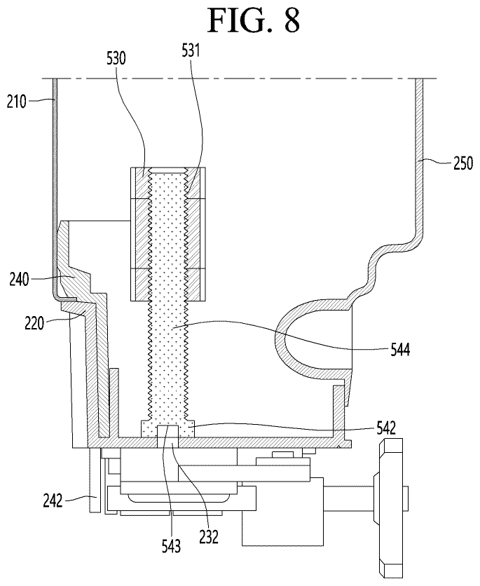

FIG. 4 is a perspective view showing a door frame 200 and a height adjusting device 50 of a first embodiment. FIG. 5 is an exploded perspective view showing an arrangement of a door frame 220, a height adjusting device 50, and hinge device 40 of a first embodiment. FIG. 6 is an exploded perspective view of a height adjusting device of a first embodiment. FIG. 7 is a front view of a height adjusting device 50 of a first embodiment. FIG. 8 is a cross-sectional view taken along line 8-8 of FIG. 3.

Referring to FIGS. 4 to 8, in the embodiment, a guide member 270 may be positioned at or within the first door 21 and movable relative to the first door 21.

When a height adjusting device 50 of the embodiment is operated, the first door 21 may be raised or lowered in a state in which the guide member 270 is supported by the flange or the extension 412 of the hinge body 410.

The height adjusting device 50 may include a first member 510.

The first member 510 may be connected to the guide member 270 or formed integrally with the guide member 270.

The first member 510 may be a fixed member whose position is fixed during a height adjusting process. The first member 510 may include a first body 512 extending upward from the guide member 270, and a second body 514 extending from the first body 512 in a horizontal direction.

At least a portion of the second body 514 may not overlap the guide member 270 in a vertical direction. The second body 514 may be positioned higher than the pin slot 272.

The second body 514 may include a first inclined surface 515. The inclined surface 515 may, for example, be inclined in a direction away from the first body 512 from an upper side to a lower side. So, the first inclined surface 515 may face the lower portion of the door.

The second body 514 may include a first stopper 516 positioned at an upper side of the first inclined surface 515 and a second stopper 517 positioned at a lower side of the first inclined surface 515. The first stopper 516 and the second stopper 517 may protrude from the first inclined surface 515.

On the other hand, the second body 514 may have a recess formed therein, and a recessed surface may be an inclined surface. Upper and lower walls forming the recess may function as stoppers.

The height adjusting device 50 may further include a second member 520. The second member 520 may be movable relative to the first member 510.

The second member 520 may include a portion extending in a horizontal direction. At least a portion of the second member 520 may be positioned at an upper side of the auto closing device 60. At least a portion of the second member 520 may overlap the auto closing device 60 in a vertical direction.

Therefore, interference between the second member 520 and the auto closing device 60 during an operation of the second member 520 may be prevented.

The height adjusting device 50 may further include a third member 530. The third member 530 may be movable relative to the second member 520. The third member 530 may be moved up and down by an external operating force.

The second member 520 and the third member 530 may be movable members whose positions are variable during the height adjusting process.

At this time, the third member 530 may only move up and down directions during the height adjusting process. Conversely, the second member 520 may move in up and down directions and left and right direction during the height adjusting process.

The second member 520 may be positioned between the first member 510 and the third member 530.

At least a portion of the third member 530 may be positioned at an upper side of the auto closing device 60. At least a portion of the third member 530 may overlap the auto closing device 60 in a vertical direction.

According to this arrangement, components constituting the height adjusting device 50 may be positioned close to a periphery of the hinge device 40 and the auto closing device 60. The height adjusting device 50 may be compact.

According to the above arrangement, a length of the second member 520 may be reduced, so that a possibility of damage to the second member 520 during an operation of the second member 520 may be reduced and a power transmission efficiency can be increased.

The third member 530 may include a second inclined surface 532. The second inclined surface 532 may be inclined in a direction closer to the first member 510 as going from a lower side to an upper side. So, the second inclined surface is facing downwardly to the bottom.

An inclination of the first inclined surface 515 may be the same as an inclination of the second inclined surface 532.

The third member 530 may include a first stopper 533 positioned at an upper side of the second inclined surface 532 and a second stopper 534 positioned at a lower side of the second inclined surface 532. The first stopper 533 and the second stopper 534 may protrude from the first inclined surface 532.

The third member 530 may have a recess formed therein, and a recessed surface may be an inclined surface. Upper and lower walls forming the recess may function as stoppers.

The second member 520 may include a first contact surface 522 in contact with the first inclined surface 515. A length of the first contact surface 522 may be less than a length of the first inclined surface 515.

In a state in which a height of the first door 21 is adjusted to a maximum height, the second member 520 may be in contact with the first stopper 516 of the first member 510.

In a state in which the height of the first door 21 is adjusted to a minimum height, the second member 520 may be in contact with the second stopper 517 of the first member 510.

The second member 520 may further include a second contact surface 524 in contact with the second inclined surface 532. A length of the second contact surface 524 may be less than a length of the second inclined surface 532.

In a state in which the height of the first door 21 is adjusted to a maximum height, the second member 520 may be in contact with the first stopper 533 of the third member 530.

When the height of the first door 21 is adjusted to a minimum height, the second member 520 may be in contact with the second stopper 534 of the third member 530.

The height adjusting device 50 may further include a fourth member 540. The fourth member 540 may be rotated relative to the third member 530. The fourth member 540 may be a member operated by a tool and may be referred to as an operating member. Alternatively, the fourth member 540 may be a transmission member that transmits an external operating force to the third member 530.

For example, the fourth member 540 may be a screw and/or may be rotatably connected to the third member 530.

The auto closing device 60 may be positioned between the fourth member 540 and the guide member 270.

A tool used by a user may be connected to the fourth member 540.

The fourth member 540 may include a body portion 544 connected to the third member 530, and a head portion 542 positioned at a lower side of the body portion 544. A diameter of the head portion 542 may be greater than a diameter of the body portion 544.

A screw thread may be formed at an outer surface of the body portion 544. A coupling hole 531 may be formed in the third member 530 to couple the body portion 544. A screw thread that engages with the screw thread of the body portion 544 may be formed at a surface forming the coupling hole 531.

The head portion 542 may be provided with a connection recess 543 to which the tool is connected.

The connection recess 543 may be, for example, a hexagonal groove, but is not limited thereto.

The connection recess 543 may be aligned with the opening 232. In this case, the tool may be connected to the connection recess 543 by passing through the opening 232. In the present embodiment, the connection recess 543 in the height adjusting device 50 may be exposed to an outside through the opening 232. Therefore, according to the present embodiment, an exposure of the height adjusting device 50 to an outside of the first door 21 can be minimized.

Alternatively, the head portion 542 may be positioned in the opening 232. That is, the connection recess 543 may also be positioned in the opening 232. In this case, the tool may be connected to the connection recess 543 positioned in the opening 232.

In the above two cases, since the fourth member 540 may be positioned inside the first door 21, an exposure of the height adjusting device 50 may be minimized.

As another example, the head portion 542 may be positioned at an outside of the first door 21. In this case, the body of the fourth member 540 may be connected to the third member 530 by passing through the opening 232. The tool may be connected to a connection recess 543 positioned at the outside of the first door 21.

Meanwhile, the door frame 220 may include a first wall 231 forming the handle 220.

The door frame 220 may further include a second wall 234 forming a receiving space for receiving the auto closing device 60. The second wall 234 may be positioned spaced apart from the first wall 231.

The door frame 220 may further include a third wall 235 that forms a space in which the guide member 270 is positioned. The third wall 235 may be positioned spaced apart from the second wall 234.

The first door 21 may further include a case 550 that receives the height adjusting device 50.

The case 550 may be coupled to the door frame 220. The guide member 270 may pass a space formed by the third wall 235.

A height of the case 550 may be adjusted by the height adjusting device 50. Since the case 550 is coupled to the door frame 220 and exists as a single assembly with the first door 21, the height of the first door 21 may be adjusted when the case 550 moves up and down.

The case 550 may include a first case 560 and a second case 562 that are coupled to each other.

The first case 560 and the second case 562 may be coupled to form a space in which the first to third members 510, 520, and 530 are positioned.

The space may include a first space 574 in which the first member 510 is positioned, a second space 575 in which the second member 520 is positioned, and a third space 576 in which the third member 530 is positioned.

Each of the first case 560 and the second case 562 may include a first portion 571 forming the first space 574, a second portion 572 forming the second space 575, and a third portion 573 forming the third space 576.

At least one of the first case 560 or the second case 562 may include a coupling portion 564 for coupling to the door frame 220.

A left-right width (e.g., maximum width) of the first space 574 may be formed to correspond to a left-right width (e.g., maximum width) of the first member 510. A vertical length of the first space 574 may be formed to be greater than a vertical length of the first member 510.

Therefore, when the first member 510 is positioned in the first space 574, a left-right movement of the case 550 is restricted, and a vertical movement of the case 550 is possible.

A vertical length of the second space 575 may be formed to correspond to a vertical length of the second member 520. Accordingly, in a state in which the second member 520 is positioned in the second space 575, the case 550 may move vertically together with a vertical movement of the second member 520. In addition, the second member 520 may move left and right directions in the drawing in the second space 575.

A left-right width (e.g., maximum width) of the third space 576 may be formed to correspond to a left-right width (e.g., maximum width) of the third member 530. A vertical length of the third space 576 may be formed to be greater than a vertical length of the third member 530.

Therefore, in a state in which the third member 530 is positioned in the third space 576, a left-right movement of the case 550 is restricted, but a vertical movement of the case 550 is possible.

At least a portion of the body portion 544 of the fourth member 540 may be positioned in the third space 576. The head portion 542 may be positioned outside the third space 576.

Meanwhile, a door liner 250 may be positioned at a rear side of the front panel 210. The door liner 250 may be connected to the door frame 220.

The front panel 210, the door liner 250, and the door frame 220 may form an insulation space into which foaming solution may be injected.

The foaming solution injected into the insulation space may be hardened to form an insulator. At this time, since the height adjusting device 50 is received inside the case 550, the insulator may be prevented from being in contact with the height adjusting device 50, and the height adjusting device 50 may operate stably.

The first door 21 may further include a plate 240 coupled to the door frame 220. The plate 240 may include a shielding portion 242 covering the stopper 282.

The shielding portion 242 may be positioned in front of the stopper 282 by passing through one side of the door frame 220. As another example, it is also possible that a separate plate 240 does not exist and only the shielding portion 242 extends from the door frame 220. An exposure of the stopper 282 to a front side of the first door 21 may be reduced by the shielding portion 242.

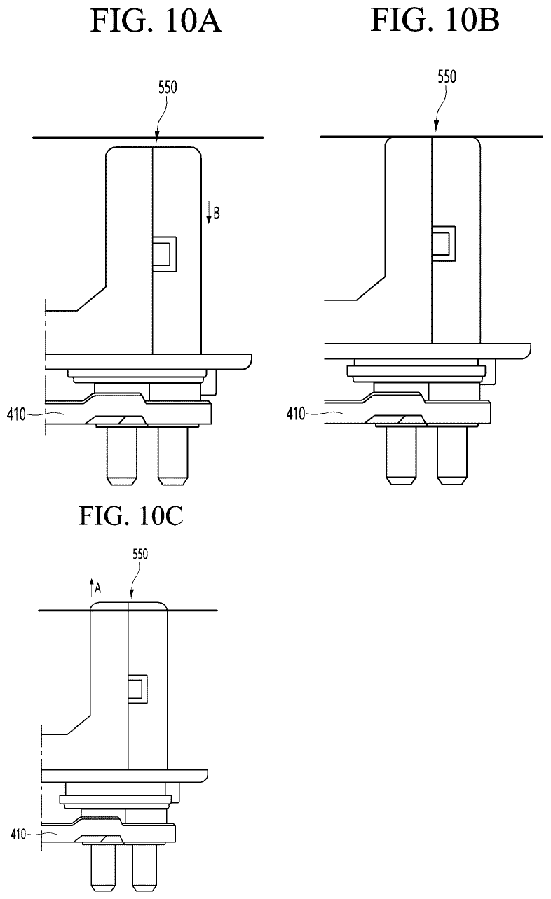

FIGS. 9A to 9C are drawings showing relative positions of a case and a height adjusting device 50 when a height of the first door 21 is adjusted according to a first embodiment. FIGS. 10A to 10C are drawings showing relative positions of a case 550 and a guide member 270 of a first door 21 when a height of a first door 21 is adjusted according to a first embodiment.

Based on FIG. 9B, FIG. 9A shows a state in which a height of the first door 21 is lowered, and FIG. 9C shows a state in which the height of the first door 21 is increased.

Based on FIG. 10B, FIG. 10A shows a state in which the height of the first door 21 is lowered, and FIG. 10C shows a state in which the height of the first door 21 is increased.

Referring to FIGS. 4 to 10, in order to adjust the height of the first door 21, the user can connect a tool to the connection recess 543 of the fourth member 540 when the first door 21 is in a closed or opened state.

The tool can be rotated in one direction to decrease the height of the first door 21. The tool can be rotated in the other direction to increase the height of the first door 21.

In a state such as FIG. 9B, when the tool is rotated in one direction, the fourth member 540 may be rotated in the one direction.

Since the third member 530 is positioned in the third space 576 in a polygonal shape, when the fourth member 540 is rotated in one direction, a rotation of the third member 530 is limited, and in response to a rotation of the fourth member 540, the third member 530 moves in an A direction within the case 550, causing the third member 530 to move upward.

When the third member 530 moves upward, the second inclined surface 532 of the third member 530 moves upward. Then, a force pressing the second contact surface 524 is removed, and the second member 520 moves in a C direction, and the second member 520 moves downward in a B direction. For example, as the third member 530 rises, the second member 520 moves downward by a load of the first door 21 and the second member 520, causing the second member 520 to move in the C direction.

Then, finally, the case 550 moves in the B direction, and the height of the first door 21 decreases as shown in b of FIG. 9A and FIG. 10C.

On the other hand, in a state such as FIG. 9B, when the tool is rotated in the other direction, the fourth member 540 may be rotated in the other direction.

Since the third member 530 is positioned in the third space 576 in a polygonal shape, when the fourth member 540 is rotated in the other direction, a rotation of the third member 530 is limited, and in response to a rotation of the fourth member 540, the third member 530 moves in the B direction within the case 550, causing the third member 530 to move downward. When the third member 530 moves downward, the second inclined surface 532 of the third member 530 moves downward. Then, the second contact surface 524 slides with the second inclined surface 532, causing the second member 520 to move in a D direction.

When the second member 520 moves in the D direction, the first contact surface 522 of the second member 520 slides along the first inclined surface 515, causing the second member 520 to move upward.

Then, the case 550 ultimately moves in the A direction, increasing the height of the first door 21, as shown in FIG. 9C and FIG. 10C.

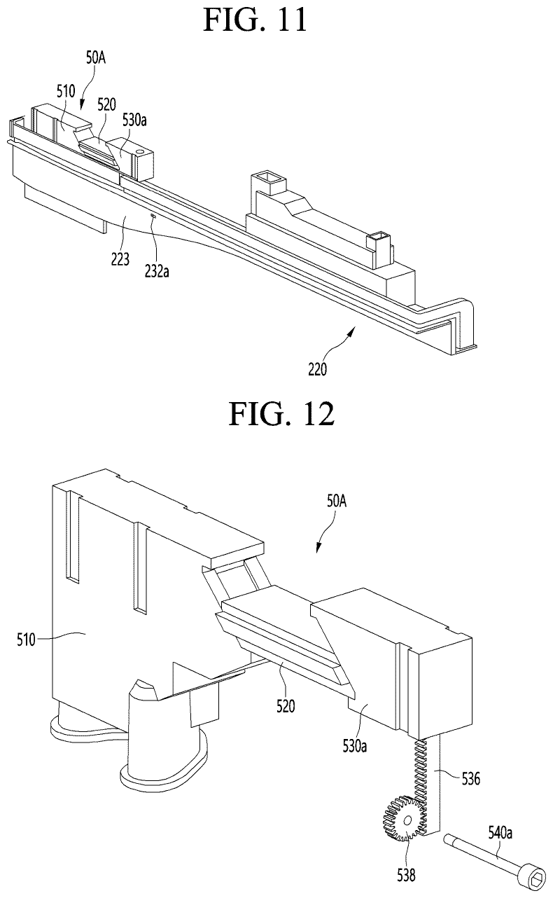

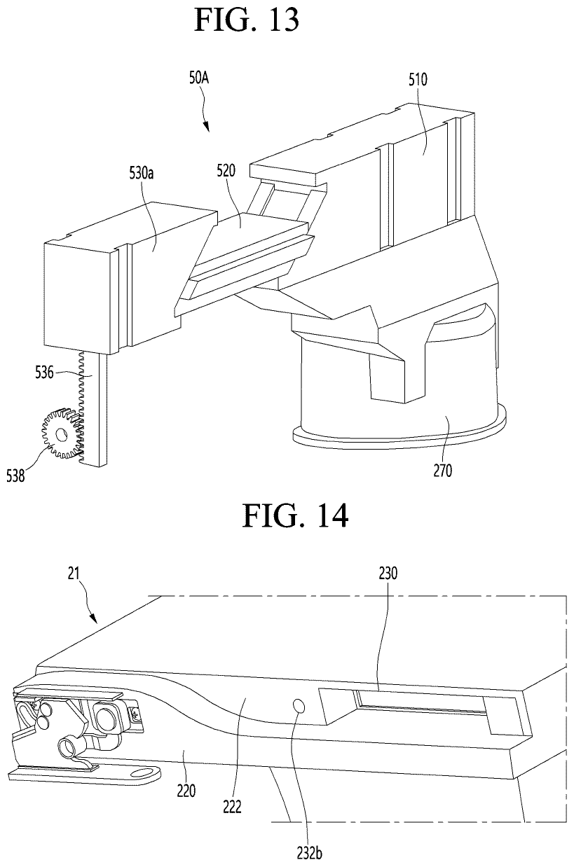

FIG. 11 is a drawing showing a position of an opening to which a tool for height adjustment is connected at a first door according to a second embodiment. FIGS. 12 and 13 are drawings showing a height adjusting device according to a second embodiment.

This embodiment is identical to the first embodiment in other respects, except that there is a difference in a position of the opening through which a tool for height adjustment passes and a structure of the height adjusting device. Therefore, characteristic parts of this embodiment will be described below, and the same drawing reference numerals will be used for the same components as the first embodiment.

Referring to FIGS. 11 to 13, in the first embodiment, an opening for a tool for height adjustment formed in the first surface 221 of the door frame 220 is described, but in the second embodiment, an opening 232a for a tool for height adjustment may be formed in the third surface 223 of the door frame 220. In this case, the tool can be easily approached to the opening 232a without opening the first door 21.

The height adjusting device 50A of the second embodiment may include a first member 510, a second member 520, and a third member 530a.

A shape and an operation of the first member 510 and the second member 520 are identical to those of the first embodiment, so a detailed description thereof will be omitted.

A basic shape of the third member 530a may be identical to a shape the third member 530 of the first embodiment. However, in the second embodiment, the third member 530a may include a rack 536 on which gear teeth are formed. For example, the rack 536 may extend downward from the third member 530a. That is, the rack 536 may extend in a vertical direction.

The height adjusting device 50A may further include a pinion gear 538 connected to the rack 536.

The height adjusting device 50A may further include an operating member 540a connected to the pinion gear 538. The operating member 540a may also be referred to as a fourth member. The operating member 540a may be formed in the same shape as the fourth member 540 of the first embodiment. That is, the operating member 540a may also include a head portion and a body portion, and a connection recess may be formed in the head portion. The connection recess of the head portion may be aligned with the opening 232a. An arrangement relationship between the connection recess and the opening 232a may be the same as an arrangement relationship between the connection recess and the opening described in the first embodiment.

The operating member 540a may be arranged, for example, in a horizontal direction.

The third member 530a may move in a vertical direction by a rotation of the pinion gear 538.

In the second embodiment, the first to third members 510, 520, and 530a may be received within the case 550 as described in the first embodiment. On the other hand, the pinion gear 538 and the operating member 540a may be positioned at an inside or outside of the case 550.

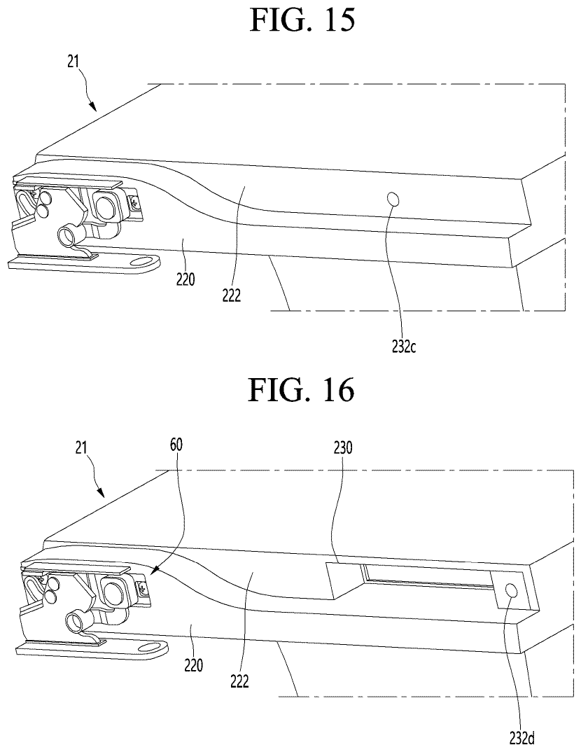

FIG. 14 is a drawing showing a position of an opening for a tool of a third embodiment. FIG. 15 is a drawing showing a position of an opening for a tool of a fourth embodiment. FIG. 16 is a drawing showing a position of an opening for a tool of a fifth embodiment.

First, referring to FIG. 14, an opening 232b for the tool may be formed in the second surface 222 of the door frame 220. At this time, the opening 232b may be positioned in an area between the auto closing device 60 and the handle 230.

In accordance with a position of the opening 232b of the third embodiment, a shape or size of at least the third member 530 of the height adjusting device may be varied, and a length of the second member 520 may be increased.

Next, referring to FIG. 15, it is also possible that the handle 230 is removed from the first door 21 and the opening 232c is formed at a position where the handle 230 is positioned. Alternatively, the opening 232c may be formed in a wall forming the handle 230 within a range that does not interfere with structures surrounding the handle 230. For example, if a light emitting portion for emitting light to the handle 230 exists around the handle 230, the opening 232c may be formed at a position that does not interfere with the light emitting portion.

That is, when the first door 21 is divided into two halves in the left and right directions, the guide member 270 and the auto closing device 60 may be positioned in a left region, and the opening 232c may be positioned in a right region. In this case, the third member 530 may be positioned in the right region. A portion of the second member 520 may also be positioned in the right region. Thus, interference between the height adjustment device 50 and the auto closing device 60 is avoided. Furthermore, the accessibility of the opening for adjusting the height of the door 21 is improved.

Next, referring to FIG. 16, an opening 232d for the tool may be positioned at an opposite side of the auto closing device 60 with respect to the handle 230. That is, the handle 230 may be positioned between the opening 232d and the auto closing device 60.

In the above embodiments, the first door 21 is described as a single door, but in contrast, even if the first door 21 includes a main door connected to the cabinet body 10 and a sub door rotatable with respect to the main door, the height adjusting device described above can be used. That is, the height adjusting device may be positioned at the main door, and the opening for the tool may also be positioned at various positions at the main door.

To summarize the above embodiments, a size and/or position of the height adjusting device may be changed depending on a change in the position of the opening. However, in common, a portion of the height adjusting device (or opening) may be positioned farther from the guide member 270 than a rotation center A1 of the lever 620. In addition, in common, a portion of the height adjusting device may overlap the auto closing device in a vertical direction.

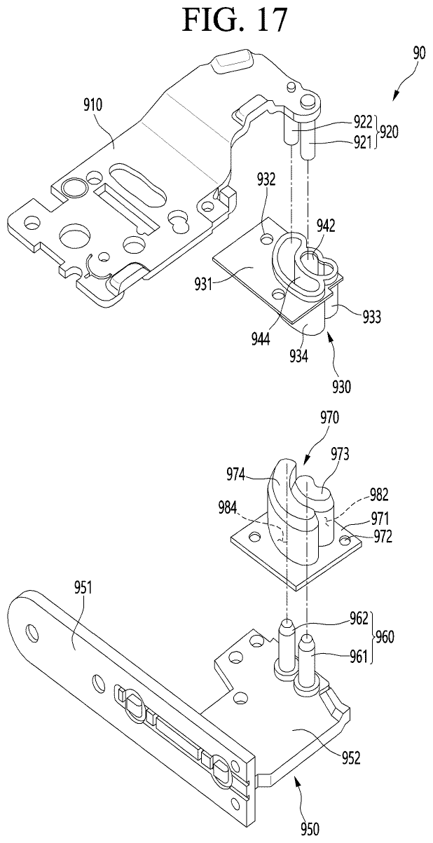

FIG. 17 is a drawing showing a hinge device of a sixth embodiment. This 6^{th} embodiment is identical to the first embodiment in other respects, except that there is a difference in a shape of the guide member. Therefore, only characteristic parts of this embodiment will be described below.

Referring to FIG. 17, a hinge device of the sixth embodiment may include an upper hinge device 90 and a lower hinge device 950.

The upper hinge device 90 may include a first hinge body 910 and a first pin unit 920.

The first pin unit 920 may, for example, extend from the first hinge body 910 toward the first door 21. The first pin unit 920 may extend downward from the first hinge body 910.

The first pin unit 920 may include a first pin 921 and a second pin 922. The first pin 921 and the second pin 922 may be spaced apart from each other in the first hinge body 910.

A basic shape and function of the first pin 921 and the second pin 922 are the same as the first pin and the second pin of the first embodiment, so a detailed description thereof will be omitted.

The upper hinge device 90 may include a first guide member 930. The first guide member 930 may be provided on the first door 21. The first guide member 930 may form a first pin slot.

The first pin slot may include a first slot 942 for receiving the first pin 921 and a second slot 944 for receiving the second pin 922. The first slot 942 and the second slot 944 may be spaced apart from each other and separated from each other.

The first guide member 930 may include an extension 931 for being connected to the first door 21. A coupling hole 932 for a coupling member to pass through the extension 931 may be formed. The coupling member may be connected to the first door 21 by passing through the coupling hole 932.

The first guide member 930 may include a first body part 933 forming the first slot 942 and a second body part 934 forming the second slot 944. The first body part 933 and the second body part 934 may extend from the extension 931.

A lower hinge device 950 of the present embodiment may include a second hinge body and a second pin unit 960.

The second hinge body may include, for example, a coupling portion 951 coupled to the cabinet body 10, and an extension 952 extending from the coupling portion 951. The second pin unit 960 may be provided in the extension 952.

The second pin unit 960 may, for example, extend upward from the extension 952.

The second pin unit 960 may include a first pin 961 and a second pin 962. The first pin 961 and the second pin 962 may be spaced apart from the extension 952.

The lower hinge device 950 may further include a second guide member 970. The second guide member 970 may be provided at the first door 21.

The second guide member 970 may form a second pin slot.

The second pin slot may include a first slot 982 in which the first pin 961 is received, and a second slot 984 in which the second pin 962 is received. The first slot 982 and the second slot 984 may be spaced apart from each other and separated from each other.

The second guide member 970 may include an extension 971 coupled to the first door 21. A coupling hole 972 through which a coupling member passes may be formed in the extension 971. The coupling member may be coupled to the first door 21 by passing through the coupling hole 942.

The second guide member 970 may include a first body part 973 forming the first slot 982 and a second body part 974 forming the second slot 984. The first body part 973 and the second body part 974 may extend from the extension 971.

Even in the sixth embodiment, a rotation center of the first door 21 may be moved by the upper hinge device 90 and the lower hinge device 950.

What is claimed is:

1. A cabinet comprising:
a cabinet body having a storage space;
a door configured to open and close at least a portion of the storage space;
a hinge device configured to allow the door to rotate relative to the cabinet; and
a height adjusting device configured to adjust a height of the door,
wherein the hinge device includes:
a hinge body installed at the cabinet,
a pin unit provided at the hinge body, and
a guide member provided at the door and defining a pin slot to receive the pin unit,
wherein the height adjusting device includes:
a first member provided inside the door and connected to the guide member,
a second member movable relative to the first member, and
a third member movable relative to the second member and movable up and down by an external operating force,
wherein, when the third member moves in a first direction, the second member moves upward and the height of the door is increased, and
wherein, when the third member moves in a second direction, the second member moves downward and the height of the door is decreased.

2. The cabinet of claim 1,
wherein the height adjusting device further include a fourth member to transmit an external operating force to the third member,
wherein the door includes:
an opening defined to allow a portion of the fourth member to be exposed to an outside,
an opening defined to allow a tool for operating the fourth member to pass through, or
an opening defined to allow the fourth member to pass through.

3. The cabinet of claim 2,
wherein the fourth member is rotatably connected to the third member, and wherein when the fourth member rotates in one direction, the third member moves in the first direction, and when the fourth member rotates in another direction, the third member moves in the second direction.

4. The cabinet of claim 3,
wherein the third member includes a coupling hole to which the fourth member is connected,
a screw thread is defined on a surface defining the coupling hole, and
a screw thread interacting with the screw thread is defined on an outer surface of the fourth member.

5. The cabinet of claim 3,
wherein the door includes a first surface and a second surface having different heights, and
a third surface extending in a vertical direction to connect the first surface and the second surface, and
wherein the opening is defined in the first surface or the second surface.

6. The cabinet of claim 2,
wherein the third member includes a rack having gear teeth,
the height adjusting device further includes a pinion gear connected to the rack, and
the fourth member is connected to the pinion gear.

7. The cabinet of claim 6,
wherein the door includes a first surface and a second surface having different heights, and
a third surface extending in a vertical direction to connect the first surface and the second surface, and
wherein the opening is defined in the third surface.

8. The cabinet of claim 1,
wherein the first member includes a first body extending upward from the guide member, and a second body extending from the first body in a horizontal direction, and
wherein the second body includes a first inclined surface along which the second member slides.

9. The cabinet of claim 8,
wherein at least a portion of the second member is positioned between the third member and the second body, and
wherein the third member includes a second inclined surface along which the second member slides.

10. The cabinet of claim 9,
wherein the second member includes a first contact surface in contact with the first inclined surface and a second contact surface in contact with the second inclined surface.

11. The cabinet of claim 1,
wherein the door further includes a case installed at the door and receiving the first member, the second member, and the third member,
wherein the case moves up and down together with the second member, and
the case moves relative to the first member and the third member.

12. The cabinet of claim 1,
further comprising an auto closing device provided at one side of the guide member at the door and to provide closing force to the door during a door closing process.

13. The cabinet of claim 12,
wherein the second member is positioned at an upper side of the auto closing device and overlaps the auto closing device in a vertical direction.

14. The cabinet of claim 12,
wherein at least a portion of the third member is positioned at an upper side of the auto closing device and overlaps the auto closing device in a vertical direction.

15. The cabinet of claim 12,
wherein the height adjusting device further includes a fourth member to transmit an external operating force to the third member, and
wherein the auto closing device is positioned between the fourth member and the guide member.

16. The cabinet of claim 1,
wherein the first direction is a downward direction, and the second direction is an upward direction.

17. A cabinet comprising:
a cabinet body having a storage space;
a door configured to open and close at least a portion of the storage space;
a hinge device configured to allow the door to rotate relative to the cabinet;
a height adjusting device disposed within the door to adjust a height of the door; and
an auto closing device configured to provide a closing force to the door during a door closing process,
wherein the hinge device includes a hinge body installed at the cabinet, a pin unit provided at the hinge body, and a guide member provided at the door and defining a pin slot in which the pin unit is received,
wherein the auto closing device includes a body installed at the door at one side of the guide member, and a lever rotatable relative to the body and interacting with the hinge body, and
wherein at least a portion of the height adjusting device is positioned farther from the guide member than a rotation center of the lever.

18. The cabinet of claim 17,
wherein a portion of the height adjusting device overlaps the auto closing device in a vertical direction.

19. The cabinet of claim 17,
wherein the height adjusting device includes a first member provided inside the door and connected to the guide member,
a second member movable relative to the first member, and
a third member movable relative to the second member and movable up and down by an external operating force,
wherein when the third member moves in a first direction, the second member moves upward and a height of the door is increased, and
when the third member moves in a second direction, the second member moves downward and the height of the door is decreased.

20. A cabinet comprising:
a cabinet body having a storage space;
a door configured to open and close at least a portion of the storage space;
a hinge device configured to allow the door to rotate with respect to the cabinet; and
a height adjusting device positioned inside the door to adjust a height of the door,
wherein the hinge device includes:
a hinge body installed at the cabinet,
a pin unit provided at the hinge body and having a first pin and a second pin, and
a guide member provided at the door and defining a pin slot in which the pin unit is received,
wherein the door includes a case that is coupled to the door and defines a space in which the height adjusting device is received,
wherein the height adjusting device includes:
a first member received in the case and connected to the guide member,
a second member movable relative to the first member, and
a third member movable relative to the second member and movable up and down by an external operating force,
wherein, when the third member moves in a first direction, the second member and the case move upward and the height of the door is increased, and
wherein, when the third member moves in a second direction, the second member and the case move downward and the height of the door is decreased.
